(19) United States
(12) Patent Application Publication
(10) Pub. No.: US 2005/0283273 A1
(43) Pub. Date: Dec. 22, 2005

(54) Apparatus and method for substantially continuous delivery of a substantially constant weight of material per unit of time from a bulk storage location and for weighing, blending, and mixing conveyable materials

(76) Inventors: Allan D. Keras, Abbotsford (CA); Douglas P. Lanz, Port Moody (CA)

Correspondence Address: MALLINCKRODT & MALLINCKRODT, Suite 510, 10 Exchange Place, Salt Lake City, UT, 84111, US

(21) Appl. No.: 10/869,347

(22) Filed: Jun. 16, 2004

(51) Int. Cl. G06F 17/00; G06F 7/00

(52) U.S. Cl. 700/239; 700/230

(57) ABSTRACT

Apparatus and method for precise and substantially continuous delivery of a substantially constant weight of conveyable material per unit of time from a bulk storage location includes a plurality of conveyors, preferably a pair of conveyors, with each conveyor of the pair suspended so that its weight is measured independently. The conveyors alternate filling and emptying, so that one fills while the other empties, and before the one conveyor fills completely, the other has emptied, so it can start filling while the filled conveyor begins emptying. This provides empty and full weight readings, while maintaining a continuous flow from the bulk source. For precise and substantially continuous weighing, blending, and mixing of multiple materials in the ratio of a given recipe, multiple conveyor pairs are employed, one for each material to be accurately delivered, that discharge into a common conveyor which conveys the ratioed continuous flow to a common continuous mixer, where the output of the mixer is a continuous, homogenized bulk mixed product with the correct ratio of materials. A computer controls operation of the system.

### BACKGROUND OF THE INVENTION

1. Field

The invention is in the field of apparatus and methods for delivering a material from a bulk storage location of the material, and in the field of mixing bulk materials, particularly dry granular materials, into a mixed bulk product according to a formula having required ratios by weight of the individual bulk products.

2. State of the Art

In material handling applications, it is commonly required to deliver a given weight of material per given unit of time from a bulk storage location of such material to a mixing, processing, or use location. In a mixing situation, a final product is produced from a mix of primary ingredients. Usually, it is desired to provide at least one of the ingredients in a stream which provides an accurately measured weight of material per unit time. Often, it is desired to provide a plurality of streams of materials to be mixed in a desired weight ratio in streams which provide an accurately measured weight of each material per unit time.

In bulk applications, where tons of primary ingredients are needed to satisfy bulk orders and where the equipment capacity installed is insufficient to hold the entire order, it is normal to divide the order into batches, sized in accordance to the capacity of the installed components of the batch system. There has been no way to blend bulk ingredients in continuous flow mode, on an accurate, economical and reliable basis, so batching systems in such instances are the industry norm. The batching capacity chosen for a given production facility always is a trade off between equipment, resource, and installation costs and production capacity, and, as such, there is significant material movement inefficiencies with installed batching systems. Every batching system has the limitation in that it can only hold one batch in the batching scale, and one batch in the mixer and it takes a finite time to fill the batch scale, move the batch from the scale to the mixer, mix the batch and then move it out of the mixer to the shipping bins. While multiple scales can be installed, multiple paths for materials can be set up, and even multiple mixers can be installed, there is always the time of transporting materials from one process location to another, which leaves much of the batching system empty. In addition, only one material can be weighed up at a time on a given scale, again limiting the delivery of the primary bulk materials because of this. An additional disadvantage of such systems is that it is common to require extensive excavation to hold weigh hoppers and other mixing system components needed in a typical batch system, as most of the bulk silos have ground level discharge hoppers and these need to gravimetrically fall onto a weigh hopper, which is a gravimetrically operated device, hence needing to be at a lower elevation to function. This excavation requirement for such batching systems adds significantly to the installed cost of a new factory and this also is a limiting constraint on the production equipment that can be selected with any given budget.

U.S. Pat. No. 4,595,125 describes a dispensing and weighing system where a fixed volume of material is deposited on a conveying belt, the weight of the material per unit of belt is measured by continuously measuring the weight of a portion of the conveying belt, and the speed of a conveying belt is adjusted to feed a desired weight of material per unit of time to other ingredients to provide a mixture of ingredients on a desired weight ratio basis. The adjustment of the speed of the belt theoretically compensates for changes in the bulk density of the material being feed into the mixture. However, it has been found that, in practice, these systems are prohibitively expensive where multiple ingredients are involved. Conveying belts stretch or contract for various reasons, for example with temperature changes or with age, and a change in tension of the belt over the weighing transducer can have a significant effect on the accuracy of the weight measured. Further, material can stick to the belt which increases the weight of the belt where the material sticks and thus increases the weight measured each time that portion of the belt passes over the weight measuring transducer and material can accumulate on the belt pulleys, stretching the belt as the effective pulley diameter increases. This type of belt tensioning changes (tension and slackening) cause significant inaccuracies in the measured weight of the delivered product due to the effect of the belt changing the force on the load cells given the same material load on the belt. It would be desirable to be able to more accurately measure the weight of product delivered from a storage location.

### SUMMARY OF THE INVENTION

The invention provides a substantially continuous stream of material from a storage location with the stream of material delivering an accurately measured weight of material per unit time. The invention provides a plurality of weighing conveying means, usually two separate weighing conveying means, each independently suspended by weight measurement means which measure the weight of the weighing conveying means. A diverter, directs flow of material from the material storage location onto one of the weighing conveying means, which fills up with material, while another of the weighing conveying means is discharging its material. When discharge of material is completed by one weighing conveying means, discharge is begun from another full weighing conveying means to provide a substantially continuous flow of material. The diverter directs material to an empty weighing conveying means while a full weighing conveying means is discharging material. The weighing conveying means are variable speed so the speed of discharge of material can be adjusted to compensate for changes in the bulk density of the material being delivered. A control means, such as a computer, which may be in the form of a microprocessor or microcontroller, controls operation of the diverter and weighing conveying means in response to signals from the weight measurement means whereby the combined outflow from the plurality of weighing conveying means is a substantially constant flow of material with a substantially constant weight per unit time.

In a preferred embodiment of the invention, a variable speed primary conveying means carries material from the material storage location to the diverter. The diverter operates to alternately fill one of a pair of variable speed weighing conveyors so that as one conveyor of the weighing conveyor pair has the diverter diverting material to it so it is accumulating material thereon (filling and weighing), the other conveyor in the pair is discharging its material (emptying). The speed of each conveyor is controlled so that a conveyor is emptying at a faster speed than it fills. This is so that a weight measurement of the full weighing conveyor can be made before it starts to discharge material. The change from filling to emptying is initiated by a change in the position of the two way diverter to direct material form the storage location from the full weighing conveyor to the empty weighing conveyor. When this switch takes place, the full weighing conveyor can be weighed to determine the full load of material on the conveyor before discharge begins. Also, the weight of the empty weighing conveyor can be obtained each time it empties and before filling starts again to obtain an updated tare weight. The switching of conveyors from filling to emptying is timed so a substantially continuous measured discharge of material per unit of time, sequentially, is obtained from the weighing conveyor pair. The two way diverter is fed by the primary conveyor system which continuously delivers material to the inlet of the two way diverter from the material storage location regardless of the position of the diverter. The speed of the weighing conveyors and of the primary conveyor system is controlled in response to the actual flow rate of material to the weighing conveyors as measured by the load cell systems of the conveyors of the conveyor pair, flow calculations of the conveyor pair, and the desired delivery rate. The actual flow rate can be determined each time a weighing conveyor is filled and the speeds of the weighing conveyors and primary conveyor adjusted, if necessary, with each actual flow rate measured. In mixing systems, the desired delivery rate is determined by the required ratio of the recipe for the mixed product as set in the control system. In mixing systems where a plurality of materials are to be mixed in a preset ratio, a plurality of material delivery systems as described are used, one for each material that is to be mixed, to accurately control the ratio of the materials in the finished mixed product. Each delivery system feeds into a common continuous mixer which mixes the materials to form a homogeneous finished mixed product.

The material delivery system of the invention may be used as part of a mixing system of the invention where a plurality of such material delivery systems are used to produce a finished mixed product made up of several accurately weighed components, as part of a mixing or processing system where one delivery system of the invention is used to deliver material at a fixed weight rate to be mixed with other materials not delivered by a delivery system of the invention, such as material to be sprayed with oil delivered by a liquid spray delivery system, or used to deliver material at a fixed weight rate such as in an animal feed delivery system where it is desired to accurately deliver feed at a known fixed delivery rate but no mixing of material delivered takes place.

### THE DRAWINGS

In the accompanying drawings, which show the best mode currently contemplated for carrying out the invention:

FIG. 1 is a schematic view of a mixing system of the invention using two of the material delivery systems of the invention; and

FIG. 2, a flow diagram of a control program for the mixing system of FIG. 1.

### DETAILED DESCRIPTION OF THE ILLUSTRATED EMBODIMENTS

The invention includes both a material delivery system for delivery of a substantially continuous stream of material that can be conveyed, such as a dry granular material, from a bulk storage location, with the stream of material delivering an accurately measured weight of material per unit time, and a mixing system for accurately producing a mixed product having a desired weight ratio of component materials where one or more of the component materials is delivered by the delivery system of the invention. The delivery system will be described herein as a part of a material mixing system, but a single such delivery system may be used alone in other applications.

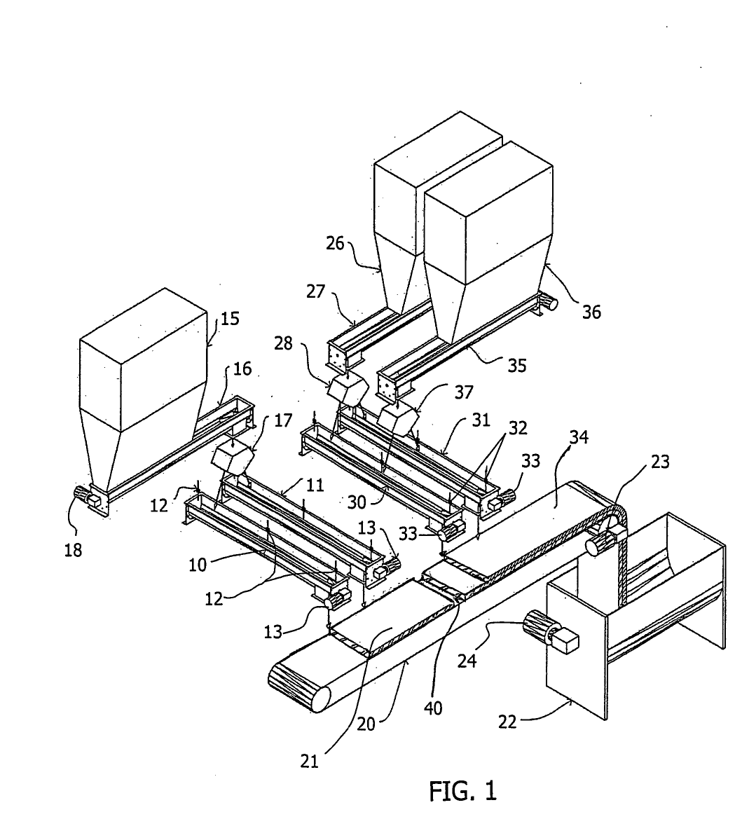

Referring to FIG. 1, a pair of weighing conveyors 10 and 11 are independently suspended so that the weight of each conveyor can be independently measured. Weight measuring means, such as load cells, measure the weight of the conveyors. The load cells may be mounted, such as at 12, so as to hang the conveyors, in which case the conveyors would not rest on a floor or other supporting surface, or load cells could be mounted between the conveyors and a lower supporting surface, such as a floor, so the conveyors rest on the load cells. In either case, the conveyors are suspended by the load cells so the load cells independently measure the weight of each conveyor. The load cells produce signals indicative of the weight measured and the signals are transmitted to a control means, such as a computer, not shown, which controls operation of the system. The conveyors are driven by variable speed motors 13.

Material to be delivered is stored in bulk storage bin 15. A primary conveyor 16 extends from the bottom of storage bin 15 to a two way diverter 17 and conveys material from bulk storage bin 15 to diverter 17. Two way diverter 17 selectively directs the material from primary conveyor 16 onto either conveyor 10 or conveyor 11. Conveyor 16 is driven by a variable speed motor 18.

The material delivered by the delivery system of the invention is the combined output of conveyors 10 and 11. The output of conveyors 10 and 11 is discharged onto conveyor 20, shown as material layer 21, which transports the material 21 to continuous mixer 22 where it is mixed into a homogeneous mixed product and discharged as the desired mixed product. Conveyor 20 is driven by motor 23 while mixer 22 is driven by motor 24.

Many mixed products will be mixtures of conveyable materials such as mixtures of dry granular materials which are easily conveyed from bulk storage bins by conveyors such as conveyor 16. Where the desired mixed product is a mixture of conveyable materials mixed in a desired weight ratio, the additional material to be mixed will be stored in an additional bulk storage bin such as storage bin 26. The material is transported from bin 26 by conveyor 27 to a two way diverter 28 which selectively directs the material onto either conveyor 30 or 31. Conveyors 30 and 31 are independently suspended by load cells 32 similarly to conveyors 10 and 11 so that the weight of each conveyor can be independently measured in the manner indicated for conveyors 10 and 11, and similarly may be variable speed conveyors driven by variable speed motors 33. The output of conveyors 30 and 31 is discharged onto conveyor 20, shown as material layer 34, which transports the material 34 to continuous mixer 22 where it is mixed with material 21 into a homogeneous mixed product.

More than one material can be fed to a single weighing conveyor pair through more than one primary conveyor system and diverter if those materials are supplied selectively on a one only basis for maximum accuracy, or in the case where more than one material on a weighing conveyor pair needs to be weighed and the bulk density of the simultaneous materials to be weighed on a single weighing conveyor pair system is considered stable, then multiple materials can be combined at a given ratio with the torque of each primary conveying system monitored to ensure material is being delivered to the weighing conveyor pair in the given ratio. For example, a second primary conveyor 35 can be positioned at the bottom of bulk storage bin 36 to convey material from bin 36 to two way diverter 37. Diverter 37 selectively directs such material to either conveyor 30 or conveyor 31, whichever is in its loading weighing mode. Thus, for accurate measurement on a one only basis, either conveyor 27 is operated to convey material from storage bin 26 to conveyors 30 or 31 or conveyor 35 is operated to convey material from storage bin 36 to conveyors 30 or 31. In cases where two materials can be combined on conveyors 30 and 31, both conveyors 27 and 35 are operated simultaneously and material from bins 26 and 36 are simultaneously deposited onto either conveyor 30 or conveyor 31.

The apparatus is controlled by a computer system programmed and configured for storing recipe requirements for the mixed product, engineering details of the apparatus, conveying engineering particulars, mechanical details such gear ratios and other details, and control algorithms to control operation and speed of the conveyors, using actual load cell feedback to compensate for changes in bulk density, so that the delivered ratio of materials matches the required recipe ratio set in the computer system, so that all materials delivered are recorded and inventory information is updated and down dated, full reporting capabilities are included, and all equipment is started and stopped safely. Thus, the computer system is connected to receive signals from the load cells representative of the weight measured, to supply control signals to the motors controlling the various conveyors and the mixer and to receive signals from the motors representative of torque, and to supply control signals to the diverters to control their operation.

The operation of an apparatus with a single storage bin and a single conveyor pair is described as follows:

Operation will be described as starting from an initial stopped condition with all conveyors and motors in the system stopped and all equipment empty of materials, except the bulk storage location 15, and with the diverter 17 set to divert material flow from conveyor 16 to one of the conveyors 10 or 11, such as to conveyor 10. In this state, it is possible to independently zero and calibrate both conveyors 10 and 11 as they are both empty. This involves the control computer reading the weight signals from the load cells suspending conveyor 10 and separately reading the weight signals from the load cells suspending conveyor 11. This indicates the weight of conveyor 10 when empty and conveyor 11 when empty. These empty weights will be referred to as “tare” weights.

When the system begins operation, continuous mixer 22 and conveyor 20, which are generally fixed speed devices, start. Variable speed conveyors 10 and 11 also start. Conveyor 16, which also has a variable speed drive system, is started with it's speed set in accordance to the required flow rate as per recipe or flow requirements and as calculated based upon an initial estimate of the bulk density of material in bin 15 or based upon the last measured bulk density of the material in bin 15 (also an estimate of the bulk density at the time of start up) and the engineering data for the mechanical configuration such as gearbox ratio and conveyor volumetric displacement which is kept in the control computer database. The rotation count of conveyor 16 is also recorded throughout its entire operation to aid in bulk density update calculations for the material it is conveying. Conveyor 16 conveys a substantially constant amount of material per unit of time.

Initially, conveyor 10 is empty. As conveyor 16 delivers material through the diverter 17 to conveyor 10, conveyor 10 begins to fill along its length. Since conveyor 16 conveys material at a substantially constant time rate, the material discharged through diverter 17 to weighing conveyor 10 is deposited on conveyor 10 at a substantially constant time rate. Conveyor 10 is operated at a controlled speed so that a given cross sectional area of material deposited on the conveyor mostly fills the conveyor at that point, regardless of the speed of conveyor 16. The fill amount of the entire conveyor is sensed by the conveyor weighing system, i.e., by load cells 12 suspending conveyor 10, and the location of the material as it accumulates along its length is known by the speed the conveyor is set to and the time it has been operating. As part of the operating program for the system, a fully loaded condition of the weighing conveyor has been defined based upon the amount of material accumulated along the length of the conveyor as measured by the speed of the conveyor and the time it has been operating since start of filling. This fully loaded condition has been defined to provide time for weighing the fully loaded conveyor prior to the material reaching the discharge end of the conveyor. Also, based upon the desired time delivery rate of material to be discharged from the weighing conveyor which is determined by conveyor characteristics such as conveyor operating speed range and material carrying capacity and by the recipe being followed, a target weight at fully loaded condition has been determined and set into the program. These parameters set into the program are determined for each recipe or other use of the system.

When conveyor 10 has reached the fully filled condition, but no material has of yet discharged at the outlet of conveyor 10, diverter 17 is switched to divert the material from conveyor 16 to begin filling conveyor 11. At this point, conveyor 10 has not yet conveyed its material to its discharge end and no material has discharged from conveyor 10. The computer takes a snapshot, i.e., a reading, of the measured weight of conveyor 10 at the fully loaded condition and the computer determines the weight of material loaded onto the weighing conveyor (the weight of the fully loaded weighing conveyor less the tare weight). This measured weight is compared with the target weight and if different from the target weight, the computer updates the bulk density factor of the material being conveyed by the system and adjusts the speed of primary conveyor 16 so that the weight of material loaded onto the weighing conveyor when in fully loaded condition will more nearly match the target weight. The computer also calculates, based on the measured weight of material on conveyor 10, the speed necessary for weighing conveyor 10 to discharge the desired time rate of material. Once this is done, the speed of conveyor 10 is increased to the calculated required speed and conveyor 10 discharges its material, at the desired time rate, onto conveyor 20, which conveys the material to mixer 22. The discharge rate of conveyor 10 is set so that it discharges and is empty for a tare reading (updated measurement of the empty weight of conveyor 10), a few seconds prior to conveyor 11 reaching its fully loaded condition, so that diverter 17 can divert material flow back to conveyor 10 when conveyor 11 reaches it fully loaded condition. In this way, the weight of fully loaded conveyor 11 can be recorded just before the material reaches the discharge point of conveyor 11. With this timing, conveyor 20 will see a substantially continuous flow of material with the material alternately coming from either conveyor 10 or conveyor 11, depending on which conveyor is discharging. There may be a slight gap 40 in material 21 discharged onto conveyor 20 when conveyors 10 and 11 switch from weighing to discharging, particularly when discharge switches from conveyor 11 to conveyor 10. However, when the material being moved by conveyor 20 discharges into mixer 22 and is mixed, there will be no gap in material flow evident from the switching of conveyors 10 and 11 at the outlet stream of mixer 22. Thus, the delivery system of the invention delivers a substantially continuous flow of material to conveyor 20 and then to mixer 22.

Conveyors 10 and 11 each alternate between filling, measuring, emptying, tarring, and back to filling on a continual basis so that they have the effect of providing material on a substantially continuous basis, while they are actually weighing fixed volumes of the material, which are essentially “mini-batches”.

When the required production run has finished, then all conveyors that can be emptied are run until they are empty, thus returning the system to the initial state as described above. The operating system can be programmed to anticipate the finish of the production run so that the various conveyors are empty at the end of the run.

The conveyor pair, conveyors 30 and 31, diverters 28 and 37 and conveyors 27 and 35 are configured in a similar manner as described for conveyors 10 and 11, diverter 17, and conveyor 16. Conveyors 30 and 31 operate as described above for conveyor 10 and 11. Conveyor 27 and diverter 28 could operate as described for conveyor 16 and diverter 17 above with conveyor 35 and diverter 37 not operating. This would permit bulk density updates as described above for the material in conveyor 27, if it was the only conveyor operating, or conveyor 35 if it was the only conveyor operating. An alternate operation method is possible for operating both conveyor 27 and diverter 28 and conveyor 35 and diverter 37 simultaneously, without automatic bulk density compensation, but with automatic flow rate adjustment through the monitoring of the weights of conveyors 27 and 35 as they operate with their normal alternating cycles.

The system as show in FIG. 1 can be expanded to have any number of conveyor pairs and material feed systems that are moving material to a collection conveyor such as conveyor 20, and it is possible to have any number of collection conveyors such as conveyor 20, with any number of associated conveyor pairs connected to a continuous mixer 22. Mixer 22 takes the substantially simultaneous feeds of material and mixes them into a homogenous final product.

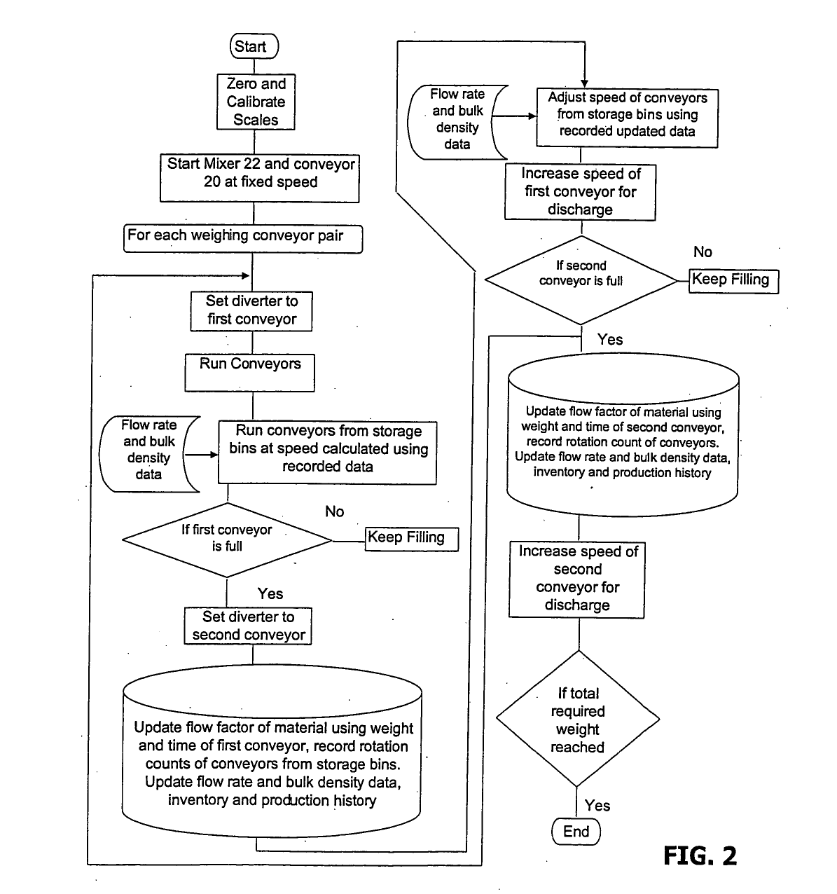

FIG. 2 is a flow diagram of a computer control program for a material delivery and mixing system of the invention. When operation starts, as indicated above, all conveyors are empty. The program zeros and calibrates the weighing scales being used. It then starts operation of the mixer 22 and conveyor 20 which delivers measured material to the mixer. Then, for each weighing conveyor pair to be used in the particular delivery operation to be performed (this could be a single pair or multiple pairs), it sets the associated diverter to deliver material to the first weighing conveyor of the pair and starts operation of both of the weighing conveyors of the pair. It also starts operation of the primary conveyor from the storage location (sometimes referred to as a storage bin) associated with the particular conveyor pair and sets the speeds of both the primary conveyor and the weighing conveyors based on flow rate and bulk density data stored in the computer. Upon start up, this is data stored in the computer either as entered into the computer by a user as estimated values or saved in the computer from a previous run of the system with similar materials, which provide estimated values for the current run. The program also controls the timing of the start up of each conveyor pair (and also the shut down when appropriate) so that material is correctly deposited on conveyor 20, as previously described, for desired mixing of the materials being delivered to mixer 22.

Upon start of operation of the conveyors from the storage bins, conveyors 16, 27, and/or 35 as shown in the embodiment of FIG. 1, and with the diverter set to the first conveyor of a pair, loading of the first conveyor of the pair of weighing conveyors begins. The program monitors the filling of the weighing conveyor being filled by, for example as described above, keeping track of the speed of the weighing conveyor being filled and the elapsed time of operation of the conveyor since filling began, to determine if the conveyor has filled to a preset amount considered as the full or fully loaded amount. During filling, as the elapsed time and speed measurements indicate the conveyor is not yet full, the program directs continued filling of the conveyor. When the elapsed time and speed measurement indicates the conveyor is full, the program operates the diverter to stop filling of the first conveyor and start filling of the second conveyor, which is empty at that time.

The program then takes a measurement of the weight of the fully loaded first conveyor to determine the weight of material on the conveyor. This will usually be done by taking the measured weight of the conveyor when in fully loaded condition after loading has stopped, and subtracting the tare weight (most recent measured weight of the empty conveyor) to provide the weight of material on the conveyor. By taking a tare weight each time the conveyor empties, correction is made for any weight changes of the empty conveyor, such as will be caused by material that builds up on the conveyor. The measured weight in fully loaded condition is compared with a target weight set in the program for the particular delivery operation being performed. If the measured weight differs from the target weight, the program will adjust the speed of the primary conveyor so that the material loaded onto the weighing conveyor during the next loading cycle will more nearly equal the target weight. To do this, the program updates the flow rate and bulk density data stored in the computer based upon the measurement of the weight of material on the weighing conveyor at fully loaded condition, and of other parameters which the program has been monitoring, such as the elapsed time of filling of the weighing conveyor to fully loaded condition and the speed of the primary conveyor from the storage location, usually determined by keeping track of the number of rotations of the primary conveyor drive during the elapsed time. The speed of the primary conveyor from the storage bin to the diverter is then adjusted based upon the updated flow rate and bulk density data. The computer also preferably keeps track of and updates the inventory and production history of the production run.

After measuring the weight of the first weighing conveyor when fully loaded, the program increases the speed of the first conveyor for discharge of material onto belt 20. This speed is calculated by the program based upon the measured weight of the fully loaded conveyor to discharge material from the conveyor onto belt 20 at the desired weight of material per unit time. Because the conveyor is traveling faster when discharging material onto belt 20 than when being loaded, the first conveyor will discharge its material and become empty before the second conveyor which is filling as the first conveyor is emptying becomes full. The program takes a tare weight measurement of the empty first weighing conveyor.

During the time the first weighing conveyor is emptying, the program monitors the second weighing conveyor during filling to determine when it reaches its fully loaded condition. When the second weighing conveyor is full, the program loops back to the block which sets the diverter to begin filling the first weighing conveyor which, because, as indicated, it has operated at a faster speed emptying than the speed at which the second weighing conveyor has filled, is then empty. When the second weighing conveyor is determined to be full and the diverter has switched to stop the filling of the second weighing conveyor, the program measures the weight of the second weighing conveyor in its fully loaded condition, compares the measured weight to the target weight, updates the flow rate and bulk density data as previously described for the first weighing conveyor, and adjusts the speed of the primary conveyor from the storage bin, if needed. The program then increases the speed of the second weighing conveyor for discharge of the material on the conveyor onto conveyor 20 at the desired delivery rate per unit time. With the increased speed of discharge, the second weighing conveyor is empty for tare weighing prior to the setting of the diverter to again fill the second weighing conveyor upon filling of the first conveyor.

During emptying of the second weighing conveyor, the program checks to see if the full weight of material needed for the production run has been, or is loaded so it will be, delivered to belt 20. To do this, the program compares the total weight of material delivered during the operating session to that time, or the weight of material it calculates has been loaded into the system during the operating session to that time that will be delivered to conveyor 20 as the conveyors empty, to the total material needed to complete the production run. If it has, additional filling of the conveyors will stop, the conveyors will be emptied, and operation of the system is ended. If not, the program continues to cycle and repeat the filling and emptying of the first and second weighing conveyors until the full production run has been completed.

Where more than one pair of weighing conveyors is used to deliver a material to the mixer, such as if either primary conveyor 27 from bin 26 or primary conveyor 35 from bin 36 is used to deliver material to weighing conveyors 30 and 31, continual adjustment for material bulk density and changes in bulk density is carried out in the manner as just described for weighing conveyors 10 and 11 and primary conveyor 16. As many weighing conveyor pairs as materials to be mixed may be used and operated in the manner described.

Where the bulk densities of particular materials to be mixed are considered to be stable, several materials may be loaded onto the same weighing conveyors to be mixed with materials from other weighing conveyors in the mixer. Thus, with the embodiment of FIG. 1, if both primary conveyors 27 and 35 operate simultaneously to deliver material from bin 26 and material from bin 36 simultaneously to either weighing conveyor 30 or 31, the desired ratios of the two materials is determined and the relative speeds of the two primary conveyors 27 and 35 are set and maintained by the program to give the desired ratios of materials. The speeds can be determined from sensing the revolutions per unit of time of the driving wheels for the primary conveyors or by measuring the rotation speed on the motors driving the primary conveyors. The delivery of the material from the weighing conveyors 30 and 31 is controlled as described for weighing conveyors 10 and 11 with the control controlling both primary conveyors 27 and 35 together to maintain the preset ratio between the two conveyors.

Various types of computers can be used to control the system, such as a programmable logic controller (PLC), personal computer, or a microcontroller. Also, various types of conveying means, such as belt conveyors, drag conveyors, screw conveyors, or other types of conveyors, as appropriate for the materials being conveyed, may be used. Similarly, various parameters of the system during operation may be sensed or measured and used to determine information needed to control operation of the system.

The invention includes the method of providing a substantially continuous delivery of a substantially constant weight of material per unit of time from a bulk storage location by providing a plurality of weighing conveying means, such as belt conveyors, screw conveyors, or other types of conveyors and independently measuring the weight of each weighing conveying means of the plurality of weighing conveying means to separately determine the weight of each. Material from the bulk storage location is directed to a selected one of the weighing conveying means of the plurality of weighing conveying means while operation of the weighing conveying means is controlled in response to the amount and weight of material loaded onto the weighing conveying means. Operation is controlled, preferably by a computer, so that as one of the weighing conveying means is filling with material, another is discharging its material so that the combined outflow from the plurality of weighing conveying means is a substantially constant flow of material with a substantially constant weight per unit time.

Whereas the invention is here illustrated and described with reference to embodiments thereof presently contemplated as the best mode of carrying out the invention in actual practice, it is to be understood that various changes may be made in adapting the invention to different embodiments without departing from the broader inventive concepts disclosed herein and comprehended by the claims that follow.

1. Apparatus for the substantially continuous delivery of a substantially constant weight of conveyable material per unit of time from a bulk storage location, comprising:
a plurality of weighing conveying means;
weight measurement means independently suspending each of the weighing conveying means of the plurality of weighing conveying means for separately determining the weight of each weighing conveying means and producing signals indicative of the weight determined;
a diverter associated with the bulk storage location for directing material from the bulk storage location to a selected one of the weighing conveying means of the plurality of weighing conveying means; and
control means for controlling and coordinating operation of the diverter and weighing conveying means and responsive to the signals from the weight measurement means to provide a combined outflow from the plurality of weighing conveying means which is a substantially constant flow of material with a substantially constant weight per unit time.

2. Apparatus for the substantially continuous delivery of a substantially constant weight of conveyable material per unit of time from a bulk storage location according to claim 1, wherein the plurality of weighing conveying means is a pair of weighing conveying means.

3. Apparatus for the substantially continuous delivery of a substantially constant weight of conveyable material per unit of time from a bulk storage location according to claim 2, wherein the control means controls operation of the diverter and weighing conveying means so that each of the weighing conveying means operates simultaneously and the diverter alternately directs material onto one or the other of the pair of weighing conveying means so that as one weighing conveying means of the pair is being loaded with material, the other weighing conveying means of the pair is discharging material, thereby providing a substantially continuous flow of material from the pair of weighing conveying means.

4. Apparatus for the substantially continuous delivery of a substantially constant weight of conveyable material per unit of time from a bulk storage location according to claim 3, wherein the control means controls operation of the weighing conveying means so that the weighing conveying means which is discharging material operates faster than the weighing conveying means that is being loaded so that the weighing conveying means discharging material is unloaded before the weighing conveying means being loaded is completely loaded whereby the unloaded weighing conveying means can be weighed to obtain a tare weight of the unloaded weighing conveying means before the diverter begins loading of the unloaded weighing conveying means.

5. Apparatus for the substantially continuous delivery of a substantially constant weight of conveyable material per unit of time from a bulk storage location according to claim 4, additionally including a primary conveying means arranged to convey material from the bulk storage location to the diverter associated with the bulk storage location, and wherein the control means controls the speed of the primary conveying means based upon signals from the weight measurement means.

6. Apparatus for the substantially continuous delivery of a substantially constant weight of conveyable material per unit of time from a bulk storage location according to claim 1, additionally including a primary conveying means arranged to convey material from the bulk storage location to the diverter associated with the bulk storage location, and wherein the control means controls the speed of the primary conveying means based upon signals from the weight measurement means.

7. Apparatus for the substantially continuous delivery of a substantially constant weight of conveyable material per unit of time from a bulk storage location, comprising:
a plurality of weighing conveying means;
weight measurement means independently suspending each of the weighing conveying means of the plurality of weighing conveying means for separately determining the weight of each weighing conveying means and producing signals indicative of the weight determined;
a diverter associated with the bulk storage location for directing material at a substantially constant flow rate from the bulk storage location to a selected one of the weighing conveying means of the plurality of weighing conveying means; and
control means for controlling and coordinating operation of the diverter and weighing conveying means in response to signals from the weight measurement means, said control means:
receiving signals from the weight measurement means and determining the weight of each of the weighing conveying means when empty with no material thereon to obtain an empty tare weight for each weighing conveying means;
operating the diverter means to direct material at the substantially constant flow rate from the bulk storage location to one of the empty weighing conveying means of the plurality of weighing conveying means and continuing to supply the material until the weighing conveying means reaches a full condition;
determining when the weighing conveying means having material directed to it reaches its full condition and then operating the diverter means to direct material at the substantially constant flow rate from the bulk storage location to an empty weighing conveying means of the plurality of weighing conveying means;
receiving signals from the weight measurement means and determining the weight of the weighing conveying means in its full condition and comparing the measured weight to the tare weight of the weighing conveying means when empty to determine the weight of material therein at it full condition;
comparing the measured weight of the weighing conveying means in its full condition with a target weight and adjusting the flow rate of material from the bulk storage location to the weighing conveying means so that the measured weight will more closely approach the target weight;
determining the speed needed to discharge the material in the weighing conveying means that is in full condition at the desired substantially constant weight per unit time;
operating the weighing conveying means at that speed when other weighing conveying means of the plurality of weighing conveying means are not discharging material to discharge the material therein and return the weighing conveying means to its empty condition;
receiving signals from the weight measurement means and determining the weight of the weighing conveying means in its empty condition to obtain a new empty tare weight for that weighing conveying means; and
operating each of the weighing conveying means of the plurality of weighing conveying means in the manner claimed so that while one of the weighing conveying means of the plurality of weighing conveying means is operating to discharge material at the substantially constant desired weight per unit time, another of the weighing conveying means of the plurality of weighing conveying means is being filled, and a weighing conveying means of the plurality of weighing conveying means is in full condition ready to begin discharge of material therein at about the time the weighing conveying means discharging material is empty to thereby provide a substantially continuous flow of the substantially constant desired weight of material per unit time from the combined plurality of weighing conveying means.

8. Apparatus for the substantially continuous delivery of a substantially constant weight of conveyable material per unit of time from a bulk storage location according to claim 7, wherein the plurality of weighing conveying means is a pair of weighing conveying means.

9. Apparatus for the substantially continuous delivery of a substantially constant weight of conveyable material per unit of time from a bulk storage location according to claim 7, additionally including a primary conveying means arranged to convey material from the bulk storage location to the diverter associated with the bulk storage location, and wherein the control means adjusts the flow rate of material from the bulk storage location to the weighing conveying means by adjusting the speed of the primary conveying means.

10. Apparatus for the continuous weighing, blending, and mixing of materials in a preset manner to form a mixed product having a specified weight ratio of at least one conveyable material stored in a bulk storage location, comprising:
a plurality of weighing conveying means associated with a bulk storage location storing a particular conveyable material to be included in the mixed product in a specified weight ratio;
weight measurement means independently suspending each of the weighing conveying means of the plurality of weighing conveying means for separately determining the weight of each weighing conveying means;
a diverter associated with the bulk storage location for directing the particular conveyable material from the bulk storage location to a selected one of the weighing conveying means;
control means for controlling and coordinating operation of the diverter and weighing conveying means and responsive to the signals from the weight measurement means to provide a combined outflow from the plurality of weighing conveying means which is a substantially constant flow of the particular material with a substantially constant weight per unit time; and
a mixer for receiving the particular material outflow from the weighing conveying means as a substantially constant flow of the particular material with a substantially constant weight per unit time and mixing it with other material of the mixed product into a substantially homogeneous mixed product.

11. Apparatus for the continuous weighing, blending, and mixing of materials in a preset manner to form a mixed product according to claim 10, wherein a mixing conveyor collects the outflow from the weighing conveying means and transports it to the mixer.

12. Apparatus for the continuous weighing, blending, and mixing of materials in a preset manner to form a mixed product according to claim 10, additionally including a primary conveying means arranged to convey material from the bulk storage location to the diverter associated with the bulk storage location, and wherein the control means controls the speed of the primary conveying means based upon signals from the weight measurement means.

13. Apparatus for the continuous weighing, blending, and mixing of materials in a preset manner to form a mixed product according to claim 10, wherein the plurality of weighing conveying means is a pair of weighing conveying means.

14. Apparatus for the continuous weighing, blending, and mixing of materials in a preset manner to form a mixed product according to claim 13, wherein the control means controls operation of the diverter and weighing conveying means so that each of the weighing conveying means operates simultaneously and the diverter alternately directs material onto one or the other of the pair of weighing conveying means so that as one weighing conveying means of the pair is being loaded with material, the other weighing conveying means of the pair is discharging material, thereby providing a substantially continuous flow of material from the pair of weighing conveying means.

15. Apparatus for the continuous weighing, blending, and mixing of materials in a preset manner to form a mixed product having a specified weight ratio of a plurality of conveyable materials each stored in a separate bulk storage location, comprising:
a separate plurality of weighing conveying means associated with each bulk storage location storing a particular conveyable material to be included in the mixed product in a specified weight ratio;
weight measurement means independently suspending each of the weighing conveying means of each plurality of weighing conveying means for separately determining the weight of each weighing conveying means;
a separate diverter associated with each separate plurality of weighing conveying means and associated bulk storage location for directing the particular conveyable material from the associated bulk storage location to a selected one of the weighing conveying means of the plurality of weighing conveying means associated with that bulk storage location;
control means for controlling and coordinating operation of each diverter and associated plurality of weighing conveying means and responsive to the signals from the weight measurement means to provide a combined outflow from each separate plurality of weighing conveying means which is a substantially constant flow with a substantially constant weight per unit time of the particular conveyable material from the bulk storage location associated with each separate plurality of weighing conveying means; and
a mixer for receiving and mixing the particular material outflow from each separate plurality of weighing conveying means into a substantially homogeneous mixed product.

16. Apparatus for the continuous weighing, blending, and mixing of materials in a preset manner to form a mixed product according to claim 15, wherein a mixing conveyor collects the outflow from each of the separate weighing conveying means and transports it to the mixer.

17. Apparatus for the continuous weighing, blending, and mixing of materials in a preset manner to form a mixed product according to claim 15, wherein the control means controls and coordinates operation of each separate plurality of weighing conveying means so that the outflow from each of the separate pluralities of weighing conveying means is collected on the mixing conveyor to be substantially simultaneously received by the mixer for mixing into the substantially homogeneous mixed product.

18. Apparatus for the continuous weighing, blending, and mixing of materials in a preset manner to form a mixed product according to claim 15, additionally including a primary conveying means associated with each bulk storage location and arranged to convey material from the associated bulk storage location to the diverter associated with that bulk storage location, and wherein the control means controls the speed of the primary conveying means based upon signals from the weight measurement means.

19. Apparatus for the continuous weighing, blending, and mixing of materials in a preset manner to form a mixed product according to claim 15, wherein each separate plurality of weighing conveying means is a pair of weighing conveying means.

20. Apparatus for the continuous weighing, blending, and mixing of materials in a preset manner to form a mixed product according to claim 19, wherein the control means controls operation of each associated diverter and weighing conveying means so that each of the weighing conveying means of each separate pair of weighing conveying means operates simultaneously and the associated diverter alternately directs material onto one or the other of the pair of weighing conveying means so that as one weighing conveying means of each pair is being loaded with material, the other weighing conveying means of the pair is discharging material, thereby providing a substantially continuous flow of material from each pair of weighing conveying means.

21. A method of providing a substantially continuous delivery of a substantially constant weight of material per unit of time from a bulk storage location, comprising:
providing a plurality of weighing conveying means;
independently measuring the weight of each weighing conveying means of the plurality of weighing conveying means for separately determining the weight of each weighing conveying means at desired times;
directing material from the bulk storage location to a selected one of the weighing conveying means of the plurality of weighing conveying means; and
controlling operation of the weighing conveying means to provide a combined outflow from the plurality of weighing conveying means as a substantially constant flow of material with a substantially constant weight per unit time.

22. A method of providing a substantially continuous delivery of a substantially constant weight of material per unit of time from a bulk storage location according to claim 21, wherein the step of controlling operation of the weighing conveying means, includes the steps of:
determining, based upon the capacity of the weighing conveying means and the preferred operating speed range of the weighing conveying means, a full condition represented by a predetermined portion of the weighing conveying means being filled with material and a target weight for the full condition;
as material from the bulk storage location is directed onto one of the weighing conveying means, determining when the full condition of that weighing conveying means is reached and stopping loading of that weighing conveying means when the full condition is reached;
determining the actual weight of material on that weighing conveying means at the full condition;
comparing the actual weight with the target weight;
adjusting the delivery rate of material to the weighing conveying means to more closely provide the target weight for a weighing conveying means when in full condition;
determining the discharge speed of that full weighing conveying means necessary to deliver the material on that weighing conveying means at the desired weight per unit of time; and
operating that full weighing conveying means at the determined speed for delivery of material thereon after emptying of another weighing conveying means of the plurality of weighing conveying means.

23. A method of providing a substantially continuous delivery of a substantially constant weight of material per unit of time from a bulk storage location according to claim 22, wherein the step of providing a plurality of weighing conveying means is the step of providing a pair of weighing conveying means; wherein the step of directing material from the bulk storage location to a selected one of the weighing conveying means is directing material from the bulk storage location alternately to a selected one of the pair of weighing conveying means, and wherein the step of controlling the operation of the weighing conveying means operates each of the weighing conveying means simultaneously and material from the bulk storage location is directed alternately onto one or the other of the pair of weighing conveying means so that as one weighing conveying means of the pair is being loaded with material, the other weighing conveying means of the pair is emptying by discharging material, thereby providing a substantially continuous flow of material from the pair of weighing conveying means.

24. A method of providing a substantially continuous delivery of a substantially constant desired weight of material per unit of time from a bulk storage location, comprising:
providing a plurality of weighing conveying means;
determining a full condition and a desired target full condition weight for each weighing conveying means of the plurality of weighing conveying means;
weighing each of the weighing conveying means when empty with no material therein to obtain an empty tare weight;
directing material at a substantially constant rate from the bulk storage location to one of the empty weighing conveying means of the plurality of weighing conveying means and continuing to supply the material until the weighing conveying means reaches its full condition;
determining when the weighing conveying means having material directed to it reaches its full condition and then directing the material to an empty weighing conveying means of the plurality of weighing conveying means;
weighing the weighing conveying means in its full condition and comparing the measured weight to the tare weight of the weighing conveying means when empty to determine the weight of material therein at it full condition;
comparing the measured weight of the weighing conveying means in its full condition with the target weight and adjusting the flow rate of material from the bulk storage location to the weighing conveying means so that the measured weight will more closely approach the target weight;
determining the speed needed to discharge the material in the weighing conveying means that is in full condition at the substantially constant desired weight per unit time;
operating the weighing conveying means at that speed when other weighing conveying means of the plurality of weighing conveying means are not discharging material to discharge the material therein and return the weighing conveying means to its empty condition;
weighing the weighing conveying means in its empty condition to obtain a new empty tare weight; and
operating each of the weighing conveying means of the plurality of weighing conveying means in the manner claimed so that while one of the weighing conveying means of the plurality of weighing conveying means is operating to discharge material at the substantially constant desired weight per unit time, another of the weighing conveying means of the plurality of weighing conveying means is being filled, and a weighing conveying means of the plurality of weighing conveying means is in full condition ready to begin discharge of material therein at about the time the weighing conveying means discharging material is empty to thereby provide a substantially continuous flow of the substantially constant desired weight of material per unit time from the combined plurality of weighing conveying means.

25. A method of providing a substantially continuous delivery of a substantially constant desired weight of material per unit of time from a bulk storage location according to claim 24, wherein the step of adjusting the flow rate of material from the bulk storage location to the weighing conveying means so that the measured weight will more closely approach the target weight includes the steps of providing a variable speed primary conveying means for supplying material from the bulk location to a diverter that directs the flow of material to the desired weighing conveying means and adjusting the flow rate of material by adjusting the speed of the variable speed primary conveying means.

26. A method of providing a substantially continuous delivery of a substantially constant weight of material per unit of time from a bulk storage location according to claim 24, wherein the step of providing a plurality of weighing conveying means is the step of providing a pair of weighing conveying means; wherein the step of directing material from the bulk storage location to a selected one of the weighing conveying means is directing material from the bulk storage location alternately to a selected one of the pair of weighing conveying means, and wherein the step of controlling the operation of the weighing conveying means operates each of the weighing conveying means simultaneously and material from the bulk storage location is directed alternately onto one or the other of the pair of weighing conveying means so that as one weighing conveying means of the pair is being loaded with material, the other weighing conveying means of the pair is emptying by discharging material, thereby providing a substantially continuous flow of material from the pair of weighing conveying means.

27. A method for the continuous weighing, blending, and mixing of materials in a preset manner to form a mixed product having a specified weight ratio of a plurality of conveyable materials each stored in a separate bulk storage location, comprising:
providing a plurality of bulk storage locations each storing a particular conveyable material to be included in the mixed product in a specified weight ratio;
providing a separate plurality of weighing conveying means associated with each bulk storage location storing a particular conveyable material to be included in the mixed product in a specified weight ratio;
independently measuring the weight of each weighing conveying means of each plurality of weighing conveying means for separately determining the weight of each weighing conveying means at desired times;
directing material from each bulk storage location to a selected one of the weighing conveying means of the plurality of weighing conveying means associated with that bulk storage location; and
controlling operation of the weighing conveying means to provide a combined outflow from the plurality of weighing conveying means as a substantially constant flow of material with a substantially constant weight per unit time.
controlling and coordinating operation of each separate plurality of weighing conveying means to provide a combined outflow from each separate plurality of weighing conveying means which is a substantially constant flow with a substantially constant weight per unit time of the particular conveyable material from the bulk storage location associated with each separate plurality of weighing conveying means;
providing a mixer for receiving and mixing the particular material outflow from each separate plurality of weighing conveying means into a substantially homogeneous mixed product; and
providing the outflow from each separate plurality of weighing conveying means simultaneously to the mixer.
